(19) United States
(12) Patent Application Publication
(10) Pub. No.: US 2026/0093491 A1
(43) Pub. Date: Apr. 2, 2026

(54) SYSTEMS AND METHODS FOR USER INTERFACE TRANSLATION BETWEEN DISTINCT MACHINE TERMINAL INTERFACE INSTRUCTIONS

(71) Applicant: Wells Fargo Bank, N.A., San Francisco, CA (US)

(72) Inventors: Omar Bryan Khan, Richmond, VA (US); Thomas E. Bell, Richmond, VA (US)

(21) Appl. No.: 18/902,764

(22) Filed: Sep. 30, 2024

(51) Int. Cl. G06F 9/30; G06Q 20/10; H04L 9/08

(52) U.S. Cl. CPC G06F 9/3017; G06Q 20/1085; H04L 9/0861

(57) ABSTRACT

Systems, apparatuses, methods, and computer program products are disclosed for translating control instructions for a machine interface. An example method includes identifying a machine based on a machine identifier. The example method further includes selecting a machine-readable interface based on the machine identifier. The example method further includes generating control data comprising instructions to cause an executable action by the machine. The example method further includes causing execution of the control data by the machine. The example method may further include contacting an NFC sensor associated with the machine. The example method may further include scanning an indicia that is within a distance of the machine. The example method may further include generating request data indicating a user request to complete the executable action by the machine. The example method may further include generating the control data comprising instructions to navigate a user interface associated with the machine.

### BACKGROUND

An Automated Teller Machine (ATM) is an electronic banking device that allows customers to perform financial transactions, such as make withdrawals, deposits, and check balances. Many ATMs usually include a Graphical User Interface (GUI) that depicts various financial transaction options on a display screen. Users can interact with the GUI by touching on-screen icons or by using physical buttons located on the ATM. For example, the ATM can include a physical keypad for numerical inputs. In addition, visual information can be provided through on-screen messages, such as account balances.

### BRIEF SUMMARY

With the rise of machine automation and Internet communication many entities (e.g., banks, retailers, manufacturers, etc.) and individuals utilize software applications and/or machines (e.g., ATMs, vending machines, industrial robots, etc.) to carryout various tasks (e.g., based on inputs, requested by individuals, etc.). For example, some banks provide their customers with mobile banking applications to monitor balances and transfer money between accounts. Some of these banks may provide ATMs to perform tasks (or operations) that require a physical interface with a customer, such as withdrawing or depositing physical currency (e.g., cash, dollars, coins, etc.). Some retailers may utilize vending machines or automated kiosks to provide more convenient service to customers. For example, retailers may use vending machines to provide products in locations where space for a retail branch is limited or unavailable. Additionally, or alternatively, automated robots may assist in checking out customers and/or retrieving products for customers from a warehouse and/or backroom of a retail outlet. Manufacturers may implement industrial robots to enhance employee productivity and/or to perform tasks (or operations) that can be hazardous to human health and/or safety. For example, industrial robots may assist in the removal of hazardous waste to limit human exposure. Additionally, or alternatively, industrial robots may perform simple repetitive task (e.g., under human supervision) to reduce the risk of repetitive strain injuries (e.g., carpal tunnel syndrome, etc.).

While software applications (e.g., mobile applications, websites, etc.) and automated machines (e.g., ATMs, etc.) can provide many benefits, traditionally, it has been difficult and frustrating for users to learn to interact effectively with the wide variety of different application and/or machine interfaces. For example, a banking customer may be familiar with the user interface (e.g., menu options, etc.) of their home bank's ATMs, however, they may be forced (e.g., based on their location) to use another bank's ATM with a different (and/or unfamiliar) user interface. Additionally, or alternatively, vending machines, industrial robots, and other automated machines are often configured with a user interface that is specific to a particular manufacturer (or brand). This can prevent (or deter) individuals from reaping the benefits of certain machines because they may not be familiar with a particular manufacturer (or brands) machine interface. For example, a customer may want to purchase an expensive product (e.g., electronic device, headphones, etc.) from a vending machine (e.g., at an airport or any other location), however, the customer may not make the purchase because they are unfamiliar with that particular vending machine interface. For instance, the customer may not even attempt to use the vending machine out of a fear that they will lose money purchasing the wrong item (e.g., which they cannot return to the vending machine for a refund). Accordingly, it has been difficult for users to fully leverage the benefits of different application and/or machine interfaces due to the number and variety of unstandardized (and/or proprietary, etc.) interfaces.

Traditional application and/or machine interface systems (e.g., banking applications, websites, ATMs, vending machines, industrial robots, etc.) may sometimes provide alternative interface options to users. For example, a bank's website may provide a different interface than the bank's mobile application while providing generally similar services. However, these conventional systems have traditionally been unable to allow a user to interact with a familiar interface to control an unfamiliar machine. Even within the ecosystem of a particular brand various applications and/or machines of that brand may not support the same (or similar) user interface(s). For example, banking applications (or websites) may traditionally be unable to communicate with ATMs of the same (or similar) bank(s). Additionally, or alternatively, conventional systems have been unable to facilitate communication between applications (or websites) of one entity (e.g., bank, retailer, etc.) and machines (e.g., ATMs, vending machines, etc.) of another entity (e.g., a different bank, retailer, etc.). It should be appreciated that customers may be unfamiliar and/or uncomfortable with third-party machine (e.g., ATM, vending machine, etc.) interfaces, third-party web portals, and/or the like. For example, a customer may be comfortable with a series of user interface selections needed to perform a desired action on their home bank's mobile application but may be unfamiliar (and/or uncomfortable) with how to perform the desired action on another bank's website and/or ATM interface. In such instances in which a familiar ATM (e.g., a home bank's ATM) is unavailable, the customer may be dissuaded from using another bank's ATM due to frustration with and/or an inability to complete the required steps needed to perform the desired action. Additionally, or alternatively, even if the customer is able to traverse the unfamiliar user interface successfully, the process may be slow, laborious, and/or rife with trial-and error, leading to a frustrating user experience.

In contrast to these traditional application and/or machine interface systems which constrain users to a particular interface, example embodiments described herein leverage various Artificial Intelligence (AI) systems to allow a user to navigate various machine interfaces using a single (and/or familiar) application interface. Example embodiments described herein, may comprise (or utilize) a mobile application (and/or the like) configured with one or more AI algorithms, such as a Large Language Model (LLM), artificial neural network, Generative AI (GenAI), and/or the like as described herein to translate user inputs from an interface of the mobile application to navigate a separate interface associated with a particular machine. Some example embodiments described herein may comprise (or utilize) a mobile application (and/or the like) configured with one or more AI algorithms to navigate an interactive voice response system (e.g., automated phone menu, etc.). For example, a user may use their home bank's mobile application to authenticate and to navigate a familiar mobile application interface to perform desired actions with an ATM (or another machine). The user may use their mobile banking application to select a target ATM (or other machine) and indicate one or more desired actions (and/or transactions). In response, a series of computer-executable control inputs may be generated that are specific to the target ATM (or other machine) that are effective to execute the desired action.

Accordingly, the present disclosure sets forth systems, methods, and apparatuses that provide improved systems and techniques for translating control instructions (e.g., from an application, user inputs, and/or the like) to a particular machine interface. There are many advantages of these, and other, embodiments described herein over the conventional (and/or traditional) systems described above.

One advantage is that example embodiments provide an improvement to the functionality of ATMs and/or other machines as described herein. Example embodiments may accomplish this by incorporating AI systems (e.g., LLMs, etc.) and/or a consortium interface (e.g., Application Programming Interface (API), etc.) to allow a first entity's mobile application to communicate with a plurality of other entities'machines. For example, a first bank's mobile application may use an LLM (and/or a consortium ATM API or other API) to communicate with a plurality of other banks'ATMs. Such example embodiments provide improvements to the functionality available to ATMs (and/or other machines) by increasing communication, readability, and/or user interface usability (and/or reusability), while reducing the complexity (and/or increasing manageability) of user interactions (e.g., by using a single software application instead of individual machine specific user interfaces for each specific machine).

Another advantage is that example embodiments provide an improvement to user interface technologies by translating one or more unfamiliar user interface menus into a familiar format to reduce the learning curve associated with using a machine and/or other electronic device (e.g., terminal, phone system, etc.) that is unfamiliar to a particular user. Example embodiments may accomplish this by interfacing a familiar interface (e.g., mobile banking application, etc.) with an unfamiliar interface (e.g., third-party bank's ATM, etc.) using a consortium API (e.g., an API agreed upon by similar entities, such as banks and/or ATM manufacturers). In some embodiments, the familiar interface (e.g., of a banking application, etc.) may transmit control data (and/or computer readable (and/or executable) instructions, etc.) using a consortium API to a machine (e.g., removing the need for a user to interact with an unfamiliar interface). Example embodiments may accomplish this by using one or more AI systems (e.g., LLMs, GenAI, etc.) to translate an unfamiliar interface into a familiar interface. In some embodiments, one or more AI systems may provide navigational instructions (e.g., for navigating an unfamiliar interface) to a user via a familiar interface. For example, a mobile device may capture an unfamiliar interface using a camera so that an LLM (and/or the like) may translate on-screen graphical buttons (e.g., on an ATM terminal, etc.) to a familiar interface format (e.g., of a banking application, etc.).

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale.

Some embodiments may include fewer or more components than those shown in the figures.

FIG. 1 illustrates a system in which some example embodiments may be used to facilitate translation between a user device and a machine terminal.

FIG. 2 illustrates a schematic block diagram of example circuitry embodying an interface translation system and/or mobile device that may perform various operations in accordance with some example embodiments described herein.

FIG. 3 illustrates a schematic block diagram of example circuitry embodying a particular machine that may perform various operations in accordance with some example embodiments described herein.

FIG. 4 illustrates an example flowchart for translating control instructions for a machine interface, in accordance with some example embodiments described herein.

FIG. 5A illustrates an example flowchart for connecting a user device with a particular machine, in accordance with some example embodiments described herein.

FIG. 5B illustrates an example flowchart for connecting a user device with a particular machine, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The terms “computing device” and “terminal” refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The terms “server” and “server device” refer to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “Artificial Intelligence (AI) system” refers to any computing device, server, and/or computing network comprising one or more of a Generative Artificial Intelligence (GenAI) model, Large Language Model (LLM), artificial neural network, Machine Learning (ML) model, and/or any other AI algorithms, models and/or applications as described herein.

The terms “machine” and “particular machine” refer to any automated equipment configured to execute at least one task and/or operation. Example machines may include, without limitation, one or more of an ATM, vending machine, self-checkout counter, electronic menu or self-order kiosk, industrial robot, robotic arm, maintenance robot (e.g., self-propelled vacuum, self-propelled lawnmower, self-propelled mop, etc.), servomotor, stepper motor, and/or the like as described herein. In some embodiments, a machine (or particular machine) may comprise, and/or may be communicatively coupled with, a terminal (or machine terminal) configured to provide commands, inputs, computer readable (and/or executable) instructions, and/or the like as described herein to the machine (or particular machine).

The term “consortium API” refers to any API developed, maintained, and/or adopted by a plurality of entities. In some embodiments, a consortium API may be any API developed, maintained, and/or the like by a group of organizations (or entities) working together to establish common standards and protocols. In addition, consortium APIs may increase interoperability and consistency across different machines, systems, and/or platforms within a specific industry (e.g., finance, retail, manufacturing, etc.). For example, a consortium of banks and/or ATM manufacturers may develop, use, adopt, manage, and/or agree upon a consortium ATM API that may allow ATMs from various financial institutions (e.g., banks, etc.) and/or manufacturers to communicate via common standards and protocols. Additionally, or alternatively, a consortium of retailers and/or vending machine manufacturers may develop, use, adopt, manage, and/or agree upon a consortium vending machine API that may allow vending machines from various retailers (e.g., stores, chains, etc.) and/or manufacturers (e.g., vending machine manufacturers, soft drink manufacturers, etc.) to communicate via common standards and protocols. Still other consortium APIs will be apparent in view of the present disclosure.

The term “entity-specific API” refers to any API developed, maintained, and/or adopted by a specific entity. In some embodiments, an entity-specific API may be any API developed, maintained, and/or the like by a single organization or entity to provide access to its unique services, data, and/or functionalities. In some embodiments, an entity-specific API may utilize private, restricted, and/or controlled standards and protocols tailored to the specific needs and requirements of the specific organization or entity.

### System Architecture

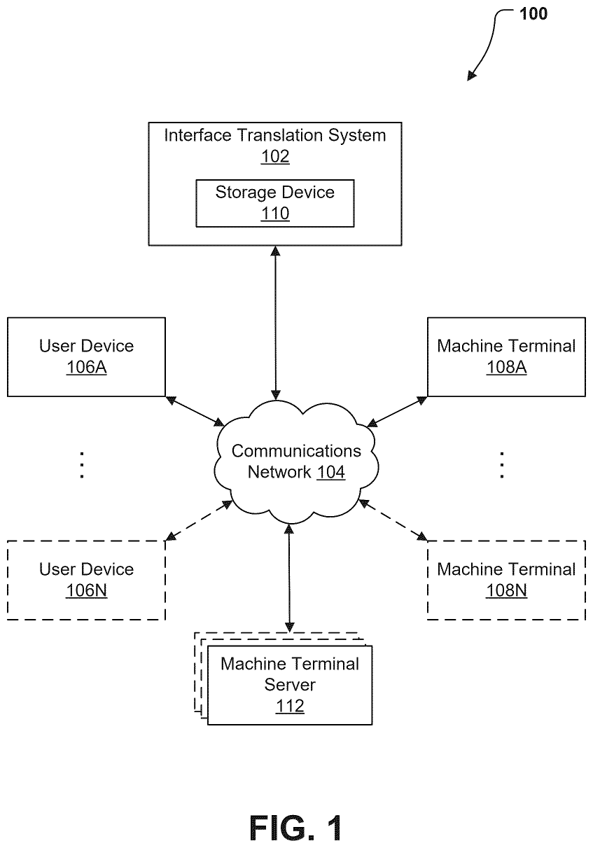

Example embodiments described herein may be implemented using any of a variety of computing devices or servers. To this end, FIG. 1 illustrates an example environment 100 within which various embodiments may operate. As illustrated, an interface translation system 102 may receive and/or transmit information via communications network 104 (e.g., the Internet, and/or the like) with any number of other devices, such as one or more of a machine terminal server 112, user devices 106A-106N, and/or machine terminals 108A-108N.

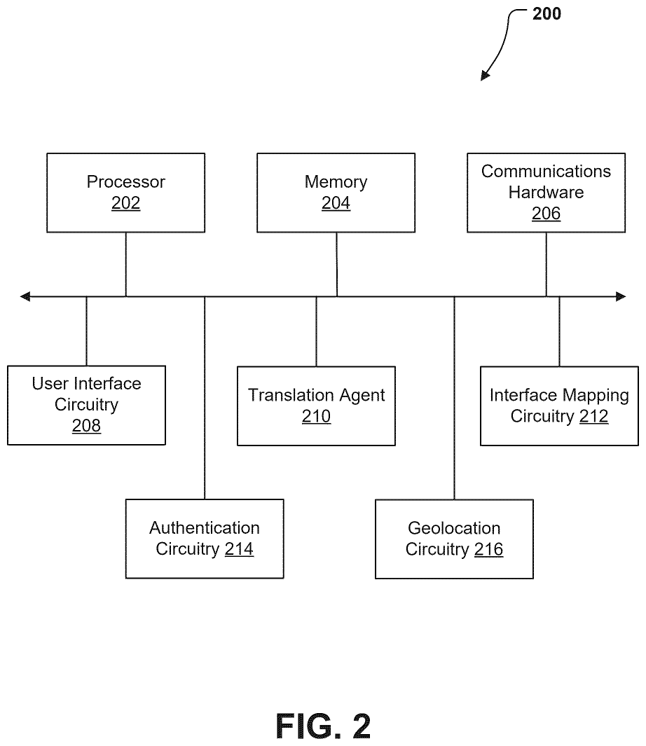

The interface translation system 102 may be implemented as one or more computing devices and/or servers, which may be composed of a series of components. Particular components of the interface translation system 102 are described in greater detail below with reference to apparatus 200 in connection with FIG. 2.

In some embodiments, the interface translation system 102 further includes a storage device 110 that comprises a distinct component from other components of the interface translation system 102. Storage device 110 may be embodied as one or more direct-attached storage (DAS) devices (such as hard drives, solid-state drives, optical disc drives, and/or the like) or may alternatively comprise one or more Network Attached Storage (NAS) devices independently connected to a communications network (e.g., communications network 104). Storage device 110 may host any computer readable software instructions (and/or computer executable software instructions) to operate the interface translation system 102 and/or any other computing device and/or machine as described herein (e.g., any or all of the user devices 106A-106N, any or all of the machine terminals 108A-108N, etc.). Storage device 110 may host any readable and/or executable software instructions for installing a software plugin, add-in, add-on, application, and/or the like as described herein, on a user device (e.g., any of user devices 106A-106N) and/or a machine (e.g., any or all of the machine terminals 108A-108N). Storage device 110 may host any readable and/or executable software instructions for communicatively coupling the interface translation system 102 via communications network 104 (e.g., the Internet, and/or the like) with any number of other devices, such as one or more of a machine terminal server 112 (e.g., comprising one or more servers associated with one or more of a bank, an ATM network, a retailer, a vending machine network, and/or the like), user devices 106A-106N and/or machine terminals 108A-108N, using an Application Programming Interface (API) and/or any other software interface as described herein.

Storage device 110 may store information relied upon during operation of the interface translation system 102, such as user profile information (e.g., a user device model and/or identifier, Operating System (OS), etc.), machine profile information (e.g., an ATM (or the like) model and/or identifier, Operating System (OS), manufacturer, automation hardware, etc.), historical user-machine interactions (e.g., most common ATM withdrawal amounts, etc.), previously translated interface maps (e.g., between a mobile application and a user interface of a particular machine, etc.), and/or any other data described herein that is used (and/or generated) during operation of the interface translation system 102. In addition, storage device 110 may store control signals, device characteristics (e.g., Operating System (OS), Internet Protocol (IP) Address, and/or the like), and/or access credentials (e.g., security certificates, passwords, handshake protocols, and/or the like) for enabling interaction between the interface translation system 102 and one or more of a machine terminal server 112, user devices 106A-106N and/or machine terminals 108A-108N.

One or more of the machine terminal server 112, user devices 106A-106N, and/or machine terminals 108A-108N may be embodied by any computing devices known in the art. The machine terminal server 112, the user devices 106A-106N, and/or the machine terminals 108A-108N need not themselves be independent devices but may be peripheral devices communicatively coupled to other computing devices. For example, the machine terminals 108A-108N may be one or more peripheral devices (e.g., touchscreens, displays, etc.) and/or computing devices communicatively coupled to (and/or integrated with) one or more particular machines (e.g., ATMs, vending machines, robots, and/or the like as described herein).

Although FIG. 1 illustrates an environment and implementation in which the interface translation system 102 interacts indirectly with a user via one or more of user devices 106A-106N, machine terminal server 112, and/or machine terminals 108A-108N, in some embodiments users may directly interact with the interface translation system 102 (e.g., via a user interface and/or communications hardware of the interface translation system 102). In some embodiments, the interface translation system 102 may comprise one or more AI systems (e.g., GenAI, LLM, machine learning models, artificial neural networks, etc.) and/or may leverage externally hosted AI systems (e.g., cloud services, web services, and/or the like, via communications network 104) to perform one or more AI operations as described herein. Whether by way of direct interaction or indirect interaction via another device, a user may communicate with, operate, control, modify, or otherwise interact with the interface translation system 102 to perform the various functions and achieve the various benefits described herein. For example, a companion application (e.g., mobile banking application, etc.) to the interface translation system 102 may be installed, at least in part, on a user device (e.g., any or all of user devices 106A-106N).

### Example Implementing Apparatuses

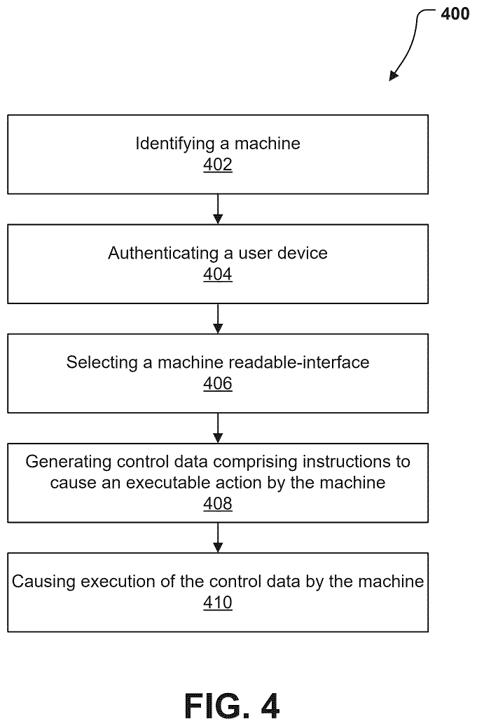

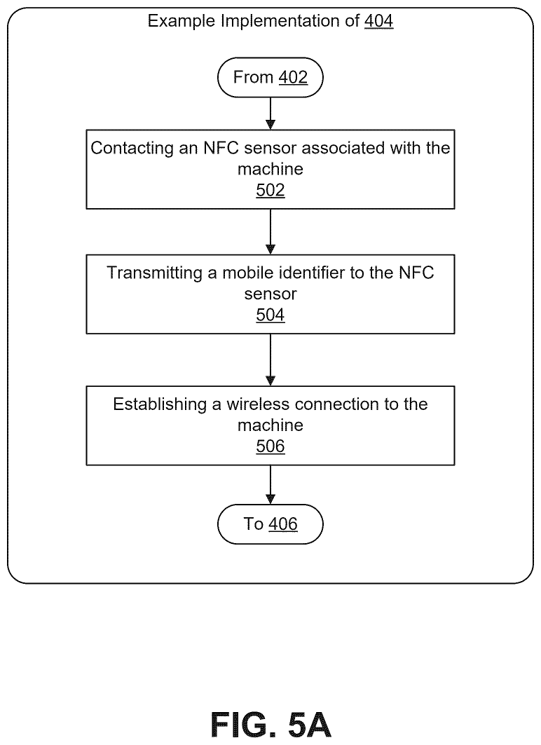

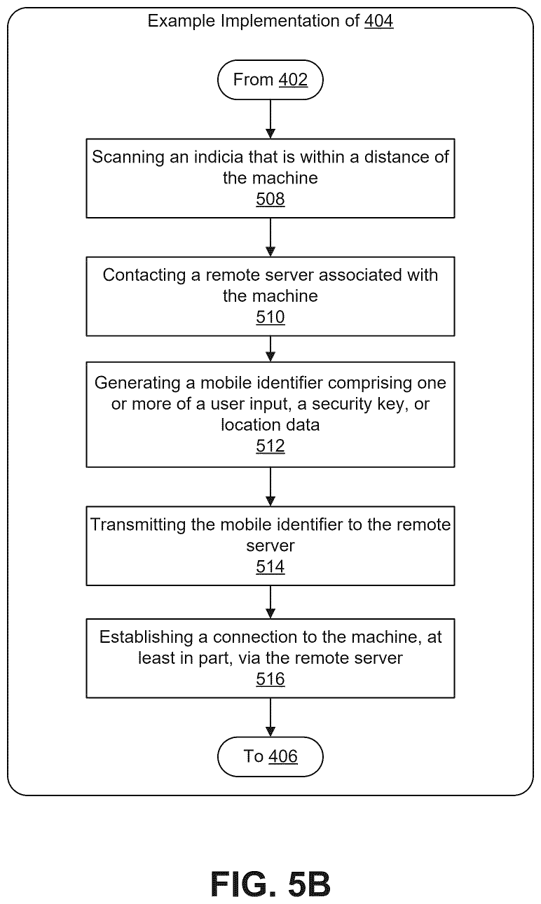

The interface translation system 102 (described previously with reference to FIG. 1) may be embodied by one or more computing devices and/or servers, shown as apparatus 200 in FIG. 2. Additionally, or alternatively, in some embodiments, a user device (e.g., any or all of user devices 106A-106N described previously with reference to FIG. 1) may be embodied by one or more computing devices, as shown as apparatus 200 in FIG. 2. The apparatus 200 may be configured to execute various operations described above in connection with FIG. 1 and/or below in connection with FIGS. 4 and 5A-5B. As illustrated in FIG. 2, the apparatus 200 may include processor 202, memory 204, communications hardware 206, user interface circuitry 208, translation agent 210, interface mapping circuitry 212, authentication circuitry 214, and geolocation circuitry 216, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud”processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processor 202 for causing transmission of such signals to a network or for handling receipt of signals received from a network. In some embodiments, the communications hardware 206 may comprise Near-Field Communication (NFC) technology, such as a sensor, receiver, transmitter, and/or the like as described herein for establishing one or more NFC communication channels (and/or connections) and/or exchanging data (e.g., transmitting and/or receiving data) with one or more other NFC capable (or enabled devices).

In addition, the apparatus 200 further comprises user interface circuitry 208 that may be any means such as a device or circuitry embodied in either hardware or a combination of hardware and software that is configured to provide output to a user and/or, in some embodiments, to receive an indication of user input. In this regard, the user interface circuitry 208 may comprise a user interface, such as a display, and may further comprise the components that govern use of the user interface, such as a web browser, mobile application, dedicated client device, or the like. In some embodiments, the user interface circuitry 208 may comprise one or more of a keyboard, mouse, display, touchscreen, touch area, keypad, Graphical User Interface (GUI), microphone, speaker, Voice User Interface (VUI) (e.g., a speech and/or voice recognition interface, phone menu, automated voice service, Interactive Voice Response (IVR) system, etc.), camera, gesture-based user interface (e.g., a hand or body movement recognition interface), facial (and/or expression) recognition interface, light (e.g., Light Emitting Diode (LED), etc.), haptic feedback interface (e.g., vibration from a haptic motor, etc.), and/or any other input and/or output device capable of rendering and/or receiving data as described herein.

The user interface circuitry 208 may utilize the processor 202 to control one or more functions of one or more of these user interface elements through software instructions (e.g., application software and/or system software, such as firmware) stored on a memory (e.g., memory 204) accessible to the processor 202. The user interface circuitry 208 may further utilize communications hardware 206 to transmit data representative of a user input and/or receive data to render as a virtual graphics output (e.g., a GUI on a touchscreen, etc.), an audible speech output (e.g., a VUI using a speaker, etc.), and/or the like as described herein. In some embodiments, the user interface circuitry 208 may utilize the processor 202 and/or the memory 204 to generate data representative of a user input (e.g., a user request, command, etc.) and/or generate virtual graphics output (and/or any other outputs as described herein), such as based on received data from a machine, a machine terminal (e.g., any or all of machine terminals 108A-108N), and/or a machine terminal server (e.g., machine terminal server 112 and/or the like).

In addition, the apparatus 200 further comprises translation agent 210 that facilitates translation of one or more interfaces between at least a user device (e.g., any or all of user devices 106A-106N) and a machine terminal (e.g., any or all of machine terminal 108A-108N). In some embodiments, the translation agent 210 may be any means such as a device or circuitry embodied in either hardware (e.g., application specific interface circuit (ASIC) and/or the like as described herein) or a combination of hardware and software (e.g., algorithms and/or the like as described herein) that is configured to translate and/or convert one or more interface elements between two or more computing devices. For example, the translation agent 210 may convert (or translate) a GUI of an ATM to another GUI of a mobile banking application (and/or a web browser) of a user device. The translation agent 210 may utilize processor 202, memory 204, and/or any other hardware component included in the apparatus 200 to perform the operations described herein (e.g., in connection with FIGS. 4 and 5A-5B). The translation agent 210 may further utilize communications hardware 206 to gather data from a variety of sources (e.g., storage device 110, machine terminal server 112, user devices 106A-106N, and/or machine terminals 108A-108N as shown in FIG. 1), and/or exchange data with a user via a user device.

In some embodiments, the translation agent 210 may comprise (or utilize) one or more of an AI system (e.g., LLM, GenAI, etc.), a consortium API, an entity-specific API, a computer language, and/or the like for converting and/or translating one or more interfaces (e.g., user interfaces, machine-readable interfaces, etc.) between different interface formats. For example, the translation agent 210 may utilize an LLM to recognize keywords in a third-party ATM's interface and convert the recognized keywords to synonymous keywords in a banking application's interface (e.g., configured to reflect the customer's home bank's ATM interface). For example, an LLM may recognize that a graphical user interface button, labeled “Get Cash,” in a first ATM interface is synonymous with (and/or equivalent to) a graphical user interface button, labeled “Withdrawal,” in a second ATM interface. In such examples, the LLM may read the “Get Cash” button on an ATM screen (e.g., via a camera, a wireless connection, etc.) and translate (or convert) the “Get Cash” button to a “Withdrawal” button on a user device's display. Additionally, or alternatively, a GenAI may generate, at least in part, a graphical user interface element (e.g., a touchscreen button icon, etc.) labeled “Withdrawal” within a GUI (e.g., banking application, etc.) of the user device. In some such examples, the GenAI may reorder, resize, and/or reposition one or more graphical user interface elements of an ATM interface when translating them to a GUI (e.g., banking application, etc.) of the user device.

The translation agent 210 may render (or cause rendering of) one or more graphical user interface elements on a display of a user device. The translation agent 210 may output (or cause outputting of) one or more audible user interface elements from a speaker of a user device. It should be appreciated that such techniques may be applied to any other machines and/or interfaces as described herein. For example, the translation agent 210 may apply the same or similar techniques (as describe herein) to translate (or convert) a vending machine interface to a GUI of a retailer's mobile application. In some examples, the translation agent 210 may apply the same or similar techniques (as describe herein) to translate (or convert) one or more machine interfaces to a VUI (e.g., associated with a companion application of the interface translation system 102).

In addition, the apparatus 200 further comprises interface mapping circuitry 212 that may map a user request to one or more user interface elements configured to execute the user request. In some embodiments, the interface mapping circuitry 212 may be any means such as a device or circuitry embodied in either hardware (e.g., application specific interface circuit (ASIC) and/or the like as described herein) or a combination of hardware and software (e.g., algorithms and/or the like as described herein) that is configured to map one or more inputs to an interface of a computing device. For example, a user may input a request to withdrawal $20.00 (or any other number) to their mobile banking application. In such examples, the interface mapping circuitry 212 may generate control data comprising a series of control instructions (e.g., that are mapped to a series of inputs associated with a particular ATM interface) that will result in the withdrawal of $20.00 (or any other number). The interface mapping circuitry 212 may generate control data comprising a series of control instructions for a particular machine interface (e.g., an ATM terminal, a vending machine terminal, etc.) based on natural language inputs to a user device. For example, the translation agent 210 may bridge (or map) an interface of a first bank's mobile application with an interface of a second bank's ATM using a consortium API (or any other techniques described herein). In some such examples, a user may provide a natural language input to the translation agent 210 (e.g., using an LLM, microphone, etc.) comprising a request, such as “Please show my checking account balance. ” In addition, the interface mapping circuitry 212 may generate control data comprising a series of control instructions that will cause the second bank's ATM to display (and/or print a receipt with) the user's checking account balance. In some embodiments, the apparatus 200 may transmit the control data to the ATM via the communications network 104 and/or a server associated with the second bank (e.g., machine terminal server 112). In some embodiments, the second bank's ATM may execute the control data (e.g., machine-readable and/or executable instructions) to simulate a user interacting with the ATM's GUI. For example, the ATM may render one or more GUI menus and/or buttons on a screen as if a user were manually interacting with the screen (e.g., pressing icons with their finger, etc.). It should be appreciated that, in such examples, the interface mapping circuitry 212 may map the user's request to the ATM's GUI by using the control data to simulate user inputs to the ATM.

In other embodiments, the interface mapping circuitry 212 may generate control data comprising a series of control instructions for a vending machine interface, a self-checkout interface, and/or any other machine and/or machine terminal as described herein. For example, a retail customer may provide a natural language input to the translation agent 210 (e.g., using an LLM, microphone, etc.) comprising a request for a vending machine, such as “Please purchase one bottle of water. ” In addition, the interface mapping circuitry 212 may generate control data comprising a series of control instructions that will cause the vending machine to execute a sales transaction to purchase a bottle of water. In some such examples, the translation agent 210 and/or the interface mapping circuitry 212 may leverage a camera (e.g., mobile phone camera, etc.) of a user device to identify where a bottle of water is located in a vending machine (e.g., in which row and column, etc.). In some other examples, the vending machine (e.g., via a consortium API, an entity-specific API, and/or any other communications) may identify which interface options are associated with a bottle of water (e.g., water bottles may be located in slots 1-4 of shelf A).

As described above, in some embodiments, the translation agent 210 and/or the interface mapping circuitry 212 may leverage an LLM (and/or another AI system) to performed one or more operations. In some embodiments, an LLM may determine if two or more words between two or more interfaces (e.g., GUI, VUI, etc.) and/or one or more user inputs (e.g., spoken requests, written requests, etc.) are similar by using keyword clustering, K-Means clustering, word embedding or vectorization techniques (e.g., Word2vec, GloVe, etc.), and/or any other semantic meaning or context grouping techniques. In some such embodiments, the LLM may comprise one or more of an artificial neural network, natural language processing (NLP) pipeline, and/or the like for vectorizing words. In some embodiments, an LLM may comprise a multi-layer (e.g., three-layer or another number) artificial neural network for leveraging Word2vec techniques (e.g., Continuous Bag of Words (CBOW) and/or skip-gram techniques), and/or any other NLP techniques, to obtain vector representations of words (e.g., keywords, etc.) from interfaces and/or user inputs (e.g., text inputs, voice inputs, etc.). In some embodiments, word vectors may represent information about the meaning of a word based on surrounding or similar words (e.g., in a sentence, paragraph, text document, phone menu recording, based on synonymous words, etc.). In some embodiments, word vectors may be any multi-dimensional numerical representation of a word mapped to nearby vectors in space. In some embodiments, words with similar (or related) meaning may be mapped to similar word vectors (e.g., similarity of vectors may be measured by cosine similarity, Euclidean distance, or other data analysis techniques for measuring semantic similarity).

In some embodiments, the apparatus 200 may use a pretrained LLM. In some embodiments, the apparatus 200 (and/or another computing device) may train an LLM to perform one or more operations as described herein. In some such embodiments, the apparatus 200 may train one or more LLMs by collecting, scrapping, and/or gathering a large dataset, such as a corpus of text documents associated with user interfaces. The large data set may be preprocessed and/or prepared for input to an LLM by cleaning and tokenizing the text into manageable units, such as words and/or vectors. In addition, the apparatus 200 (or the like) may select or identify a model architecture associated with the LLM and configure a computational environment with the necessary resources to execute the LLM. For example, the LLM may require authorization to utilize one or more processors (e.g., processor 202), Graphical Processing Units (GPUs), Tensor Processing Units (TPUs), and/or any other computational resources. The apparatus 200 (or the like) may define hyperparameters (e.g., a learning rate, training examples batch size, etc.) and assign weights to the LLM (e.g., an artificial neural network, etc.). The apparatus 200 (or the like) may run the LLM in a training loop where the LLM's assigned weights are adjusted to minimize a loss function using forward and/or backward propagation techniques. A loss function may comprise one or more of linear regression, Means Squared Error (MSE), Mean Absolute Error (MAE), and/or the like. In such embodiments, the apparatus 200 (or the like) may use periodic validation to monitor the performance of the LLM and/or prevent overfitting. Once a minimum threshold has been met for the loss function, the apparatus 200 (or the like) may evaluate the LLM using a test dataset to analyze metrics of the LLM's performance including accuracy, perplexity, and/or the like. The apparatus 200 (or the like) may deploy the LLM if one or more performance criteria are met. Performance criteria may include meeting an accuracy threshold of 95% (or any other number to within a tolerance of ±10%), a minimum response time (e.g., generating a response in 10 seconds or less), and/or the like as described herein.

In some embodiments, the apparatus 200 (and/or another computing device) may periodically retrain an LLM. In some embodiments, the apparatus 200 (and/or any other computing device) may retrain an LLM to perform one or more operations as described herein. In some such embodiments, the apparatus 200 may determine (or identify) a need for retraining based on new datasets, changes in user requests, and/or performance degradation (e.g., based on user feedback, response times, etc.). Once a need for retraining is determined, the apparatus 200 may update the LLM's training dataset with new (or additional) data. The LLM may be reset and trained as described above using the new (or additional) data. In other embodiments, the LLM may be retrained by feeding the new (or additional) data through the LLM and readjusting the assigned weights of the LLM to minimize the loss function using forward and/or backward propagation techniques. The retrained LLM may be reevaluated using a test dataset to reanalyze metrics of the LLM's performance including accuracy, perplexity, and/or the like. In some embodiments, the apparatus 200 may fine-tune the LLM by readjusting hyperparameters (described above) and retraining the LLM based, at least in part, on one or more datasets (e.g., with a lower learning rate than initially used) to avoid catastrophic forgetting (e.g., loss of previously learned information). The apparatus 200 (or the like) may evaluate the retrained model using the same metrics as described above and/or may deploy a retrained LLM if one or more performance criteria (e.g., an accuracy threshold of 95% or another number, and/or the like) are met. It should be appreciated that periodically retraining an LLM may ensure that the LLM remains effective and up-to-date with the most recent data to meet user requirements.

In addition, the apparatus 200 further comprises authentication circuitry 214 that may confirm (or verify) one or more credentials (e.g., login, password, two-factor authentication (2FA), etc.) associated with a user device (e.g., a user account, a location, etc.) based on user profile information (and/or the like) associated with an authentic (or authorized) user and/or user device (e.g., associated with a banking application, etc.). In some embodiments, the authentication circuitry 214 may be any means such as a device or circuitry embodied in either hardware (e.g., application specific interface circuit (ASIC) and/or the like as described herein) or a combination of hardware and software (e.g., algorithms and/or the like as described herein) that is configured to authenticate a computing device. The authentication circuitry 214 may utilize processor 202, memory 204, and/or any other hardware component included in the apparatus 200 to perform the operations as described herein (e.g., in connection with FIGS. 4 and 5A-5B). The authentication circuitry 214 may comprise (and/or generate) one or more of a user device identifier (e.g., serial number, etc.), a hardware-based security key, a smart card, a Physically Unclonable Function (PUF), an Integrated Circuit (IC) fingerprint, a biometric reader (or scanner), and/or any other hardware and/or software based authentication systems. The authentication circuitry 214 may utilize communications hardware 206 to gather data from a variety of sources (e.g., storage device 110, user devices 106A-106N and/or machine terminals 108A-108N, as shown in FIG. 1).

In some embodiments, the authentication circuitry 214 may utilize processor 202, memory 204, and/or the geolocation circuitry 216 to verify a user and/or user device is authorized to communicate with a machine and/or machine terminal. For example, the authentication circuitry 214 may verify that a user device is authorized to access a particular account (e.g., using a security key, login, password, etc.), such as a bank account. In addition, the authentication circuitry 214 may verify (e.g., by leveraging the geolocation circuitry 216, the machine verification agent 310, and/or the like) that a user device is located near (e.g., within a 10 foot radius, or any other number, to within a tolerance of ±10%) of a machine, such as an ATM, before allowing a user device to communicate with the machine. For instance, the authentication circuitry 214 may verify that a user device can withdrawal money from a particular bank account and the authentication circuitry 214 may verify (e.g., by leveraging the geolocation circuitry 216) that the user device is physically located near the machine (e.g., ATM, vending machine, self-checkout, etc.) at which a transaction (and/or other executable action) is being requested. In some embodiments, the authentication circuitry 214 may prevent, at least in part, sensitive data (e.g., Personally Identifiable Information (PII), encrypted data, etc.) associated with a user and/or an entity (e.g., bank, retailer, etc.) from being transmitted to user devices 106A-106N, machine terminals 108A-108N, and/or any other computing device communicatively coupled to the communications network 104. In some examples, the authentication circuitry 214 may handle any or all security verification (e.g., handshake protocols, check security certificate validity, and/or the like) associated with transmitting data via the communications network 104 (e.g., between user devices 106A-106N, machine terminals 108A-108N, machine terminal server 112, and/or the like).

In some embodiments, the authentication circuitry 214 may store user profile information (e.g., login, name, passwords, bank account numbers, user settings and/or preferences, etc.) to storage device 110 (e.g., in a secured and/or encrypted database). The interface translation system 102 may setup, collect, and/or store the user profile information during a user registration process, an account setup process, and/or the like. In some embodiments, the authentication circuitry 214 may store user device information (e.g., IP address, Medium Access Control (MAC) address, device name, serial number, user interface capabilities, etc.) to storage device 110 (e.g., in a secured and/or encrypted database). In some such embodiments, the interface translation system 102 may utilize user device information to determine whether a user device may execute transactions (e.g., with an ATM, vending machine, self-checkout terminal, etc.) and/or to identify which user devices may receive information regarding a user's transaction(s). Further, the interface translation system 102 may utilize user device information to determine how to present (or render) a translated interface to a user (via a user device) as described herein. For example, a user device with a speaker may receive a VUI and a device with a screen or display may receive a GUI. A user device with multiple user interface capabilities (e.g., a speaker, a display, touchscreen, etc.), such as a smartphone or the like, may receive one or more translated interfaces in one or more formats (e.g., VUI, GUI, etc.) based on a user setting or preference.

In some embodiments, the interface translation system 102 may utilize user device information and/or user preferences (or settings) to determine how to translate and present interfaces to a user. For example, a user may prefer GUIs to VUIs and, in such examples, the interface translation system 102 may present all machine interfaces, whether a GUI, VUI, or another interface type, to the user as GUIs on a display of a user device. Additionally, or alternatively, if a user prefers VUIs then the interface translation system 102 may translate all machine interfaces, whether a GUI, VUI, or another interface type, as VUIs on one or more speakers of a user device.

It should be appreciated that translating a GUI to a VUI (and/or a VUI to a GUI) may be an advantageous practical application for example embodiments described herein (and/or an improvement over traditional/conventional application and/or machine interface systems as described above) because the translation of interfaces between visual and/or audible formats may provide a greater degree of user accessibility by reducing barriers to users with disabilities. For example, a GUI may be problematic for users with visual impairments and, thus, translating a GUI to a VUI (and/or to another GUI, such as with larger font, more contrast, etc.) may be more beneficial for such users. Additionally, or alternatively, a VUI (e.g., an automated phone menu, etc.) may be problematic for users with hearing impairments and, thus, translating a VUI to a GUI may be more beneficial for such users.

In addition, the apparatus 200 further comprises geolocation circuitry 216 that generates and/or collects geolocation data. In some embodiments, the geolocation circuitry 216 may be any means such as a device or circuitry embodied in either hardware (e.g., application specific interface circuit (ASIC) and/or the like as described herein) or a combination of hardware and software (e.g., algorithms and/or the like as described herein) that is configured to determine a location of a computing device (e.g., a mobile device, etc.). The geolocation (or location) data may comprise one or more of Global Positioning System (GPS) coordinates, an IP address, base station (or cell tower) triangulation data, and/or any other data indicative of a physical location. The geolocation circuitry 216 may comprise one or more of a GPS receiver, a cell (and/or radio) receiver, an accelerometer, a gyroscope, a barometer, an antenna, and/or any other hardware and/or software for determining a physical location associated with the apparatus 200. The geolocation circuitry 216 may utilize processor 202, memory 204, and/or any other hardware component included in the apparatus 200 to perform the operations as described herein (e.g., in connection with FIGS. 4 and 5A-5B). The geolocation circuitry 216 may utilize communications hardware 206 to gather data from a variety of sources (e.g., user devices 106A-106N, machine terminals 108A-108N, server farms/clusters, mobile networks, Internet Service Providers (ISP), satellites, and/or any other entity associated with a computing device). The geolocation circuitry 216 may utilize the communications hardware 206 and/or the user interface circuitry 208 to exchange data with a user and, in some embodiments, may cause rendering of one or more of a map, a current location, a geofence boundary (e.g., around a machine, an ATM, a vending machine, etc.), and/or the like via a user device (e.g., on a display, GUI, etc.). The geolocation circuitry 216 may utilize geolocation mapping services (e.g., mapping service websites, applications, etc.) and/or location data received from one or more user devices 106A-106N to determine a current location of a user device and/or an associated user.

Although components 202-216 are described in part using functional language, it will be understood that the particular implementations necessarily include the use of particular hardware. It should also be understood that certain of these components 202-216 may include similar or common hardware. For example, the user interface circuitry 208, the translation agent 210, the interface mapping circuitry 212, the authentication circuitry 214, and/or the geolocation circuitry 216 may each at times leverage use of the processor 202, the memory 204, and/or the communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” or “agent” with respect to elements of the apparatus therefore shall be interpreted as necessarily including the particular hardware configured to perform the functions associated with the particular element being described. Of course, while the term “circuitry” or “agent” should be understood broadly to include hardware, in some embodiments, the term “circuitry” or “agent” may in addition refer to software instructions that configure the hardware components of the apparatus 200 to perform the various functions described herein.

Although the user interface circuitry 208, the translation agent 210, the interface mapping circuitry 212, the authentication circuitry 214, and/or the geolocation circuitry 216 may leverage the processor 202, the memory 204, and/or the communications hardware 206 as described above, it will be understood that any of the user interface circuitry 208, the translation agent 210, the interface mapping circuitry 212, the authentication circuitry 214, and/or the geolocation circuitry 216 may include one or more of a dedicated processor, specially configured Field Programmable Gate Array (FPGA), Application Specific Interface Circuit (ASIC), System on a Chip (SoC), and/or the like to perform its corresponding functions, and may accordingly leverage the processor 202 for executing software stored in memory 204, and/or communications hardware 206 for enabling any functions not performed by special-purpose hardware. In all embodiments, however, it will be understood that the user interface circuitry 208, the translation agent 210, the interface mapping circuitry 212, the authentication circuitry 214, and/or the geolocation circuitry 216 comprise particular machinery designed for performing the functions described herein in connection with such elements of the apparatus 200.

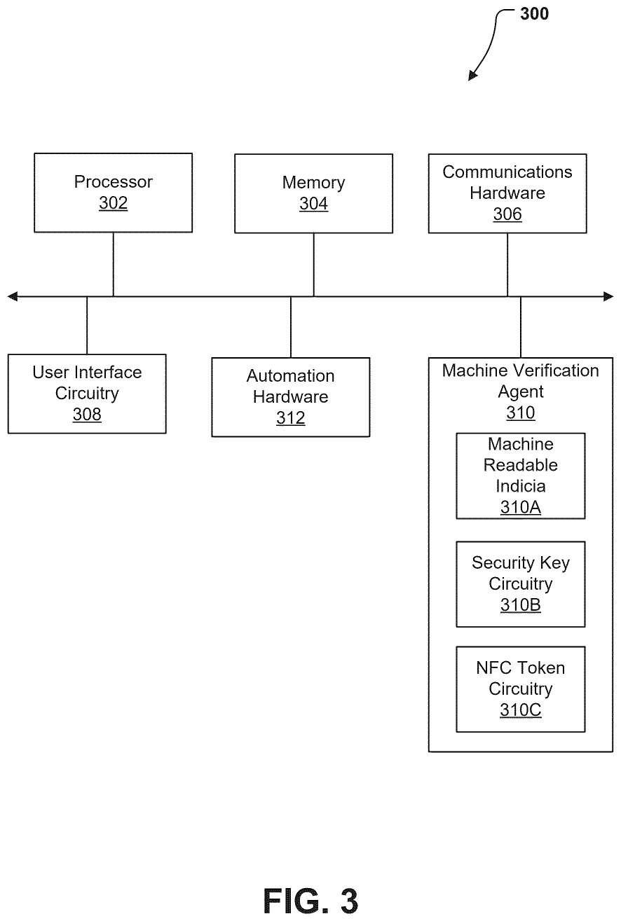

Turning to FIG. 3, as illustrated, an apparatus 300 is shown that represents an example machine terminal (e.g., any or all of machine terminals 108A-108N described previously with reference to FIG. 1). Additionally, or alternatively, in some embodiments, the apparatus 300 may represent an example server (e.g., one or more of machine terminal server 112 and/or the like as described herein). As shown, the apparatus 300 may include processor 302, memory 304, communications hardware 306, and/or user interface circuitry 308 each of which may be configured to be similar to the similarly named components described above in connection with FIG. 2.

The apparatus 300 may comprise automation hardware 312, which includes particular hardware components designed for performing (or executing) one or more specific operations and/or tasks assigned to a machine (e.g., ATM, vending machine, self-checkout terminal, etc.) as described herein. For example, the automation hardware 312 may be embodied in an ATM as one or more of a receipt printer, a cash recycler (or dispenser), a (security) camera, a (security) microphone, and/or any other automation hardware described herein capable of performing one or more ATM operations and/or tasks. Additionally, or alternatively, the automation hardware 312 may be embodied in a vending machine as one or more of a food/beverage tray, a coil spring, a motor (e.g., to turn or rotate the coil spring and dispense products), an access door, a credit card reader, a coin changer, a bill acceptor, and/or any other automation hardware described herein capable of performing one or more vending machine operations and/or tasks. Example automation hardware may comprise one or more of a motor (e.g., servomotor, stepper motor, etc.), an actuator, a pump (e.g., hydraulic, pneumatic, etc.), a wheel, a track, a bearing, a sensor (e.g., light curtain, temperature sensor, etc.), a welder, a gate/door, a camera, a microphone, a speaker, a light source (e.g., LED, lightbulb, etc.), a control circuit (e.g., FPGA, ASIC, PLC, PAC, and/or the like), and/or any other automation hardware as described herein.

The automation hardware 312 may utilize processor 302, memory 304, or any other hardware component included in the apparatus 300 to perform one or more operations for dispensing objects (e.g., products, food, currency, etc.), facilitating transactions (e.g., purchases, self-checkout, etc.), cleaning (e.g., vacuuming, mopping, landscaping, etc.), transportation (e.g., removing waste, retrieving warehouse stock, etc.), manufacturing (e.g., assembly, welding, etc.), and/or any other automated processes, operations, and/or tasks as described herein. The automation hardware 312 may further utilize communications hardware 306 to communicate with one or more computing devices, establish a communications channel via the communications network 104, receive control data (e.g., machine-readable/executable instructions, etc.), and/or transmit feedback (or performance) data from the apparatus 300 via the established communications channel. It should be appreciated, with respect to certain configurations of the automation hardware 312 as described herein, that combining particular automation hardware elements with specifically designed software instructions produces a particular special-purpose machine (e.g., ATM, vending machine, self-checkout terminal, automated vacuum, etc.) comprising the means for implementing various operations, functions, and/or tasks as described herein.

The apparatus 300 may comprise a machine verification agent 310 configured to facilitate verification that a user and/or a user device (e.g., any of user devices 106A-106N), attempting to communicate with (and/or cause execution of an action, operation and/or task on) the apparatus 300, is physically proximate or located near (e.g., within a 10 foot radius, or any other number, to within a tolerance of ±10%) the apparatus 300. In some embodiments, the machine verification agent 310 may be any means such as a device or circuitry embodied in either hardware (e.g., application specific interface circuit (ASIC) and/or the like as described herein) or a combination of hardware and software (e.g., algorithms and/or the like as described herein) that is configured to determine and/or verify that a location of a user and/or a user device is physically proximate the apparatus 300. In some embodiments, the machine verification agent 310 may receive and/or verify geolocation (or location) data (e.g., GPS coordinates, an IP address, base station (or cell tower) triangulation data, etc.) from the apparatus 200 (e.g., from the geolocation circuitry 216 as described above in connection with FIG. 2).

As shown, the machine verification agent 310 may comprise one or more of machine-readable indicia 310A, security key circuitry 310B, NFC token circuitry 310C, and/or the like as described herein. The machine-readable indicia 310A may comprise one or more of a computer readable code, a Quick Response (QR) code, a data matrix, a barcode, a randomly generated code, and/or the like for verifying that a user and/or a user device is proximate a machine, establishing a connection, and/or executing an executable action. For example, an ATM (or any other machine described herein) may be configured with a QR code that a user device must scan before the ATM will execute any control data received in relation to a request from the particular user device. In some examples, a user may identify an ATM (e.g., via a mapping service, a companion application of the interface translation system 102, etc.) prior to leaving for, and/or arriving at, the ATM. In some such examples, the apparatus 200 may transmit instructions to execute one or more executable actions, such as to withdrawal $40.00 from the ATM, in response to the user scanning an indicia and/or contacting an NFC sensor located at the ATM. For example, the user may scan the machine-readable indicia 310A (e.g., a QR code, etc.) located on or near the ATM to indicate to the interface translation system 102, the machine terminal server 112, and/or the machine terminal of the ATM that the user is physically present at the ATM and that, at least in part, the machine terminal may execute the one or more executable actions. Additionally, or alternatively, the user may contact the NFC token circuitry 310C (e.g., an NFC sensor, etc.) located on or near the ATM to indicate to the interface translation system 102, the machine terminal server 112, and/or the machine terminal of the ATM that the user is physically present at the ATM and that, at least in part, the machine terminal may execute the one or more executable actions. In some examples, the user may not identify an ATM in advance (or ahead of time) and the apparatus 200 may generate (and/or store (e.g., locally and/or remotely on a storage device)) instructions to execute one or more executable actions while the user searches for an ATM (or any other machine). In some such examples, the apparatus 200 may transmit the instructions to execute one or more executable actions to the ATM once the user scans the machine-readable indicia 310A and/or contacts the NFC token circuitry 310C. It should be appreciated that, in such examples, the user can generate (and/or store (e.g., locally and/or remotely on a storage device)) the control data for a machine prior to knowing which machine they will utilize. This may allow the user additional flexibility as they travel unfamiliar locations and/or if they do not have Internet access to use mapping service. In some embodiments, the machine-readable indicia 310A may be one or more of a label, a sticker, a sign, an engraving (e.g., on a machine terminal), printed media, digital media, and/or the like as described herein.

The security key circuitry 310B may comprise (and/or generate) one or more of a machine identifier, a random code generator, hardware-based security key circuitry, a Physically Unclonable Function (PUF), an Integrated Circuit (IC) fingerprint, and/or the like as described herein for verifying that a user and/or a user device is proximate to, and authorized to use, a machine. For example, a vending machine (or any other machine described herein) may be configured with hardware-based security key circuitry that generates a one-time random code for a user to transmit to the interface translation system 102 and/or the machine terminal server 112 (e.g., a retailer's authentication server, etc.) in order to authorize the vending machine to execute any control data received in relation to a request from the particular user device (e.g., to make a purchase, etc.). In some examples, a user may identify a vending machine (e.g., via a mapping service, a retailer's website, etc.) and transmit instructions, using the interface translation system 102, to purchase food (or any other product) prior to arriving at the vending machine. In some such examples, the user may scan (or type into an interface) a one-time random code generated by the security key circuitry 310B to provide the one-time random code to the interface translation system 102 and/or the machine terminal server 112 to indicate that the user is physically present at the vending machine and that the food (or any other product) may be dispensed. In some examples, a user may identify a machine and transmit instructions, using the interface translation system 102, to the machine to execute one or more operations prior to arriving at the machine without a user device. For example, a user may transmit control data to a vending machine (e.g., along their jogging route) to dispense a water bottle upon their arrival (e.g., without a user device). In some such examples, the user may be presented with a one-time random code (e.g., numeric code, alpha-numeric code, word, phrase, etc.) generated by the security key circuitry 310B (and/or the machine terminal server 112) at the time the user transmits the request. Upon arrival at the vending machine, the user may enter the one-time random code (e.g., numeric code, alpha-numeric code, word, phrase, etc.) into a machine terminal of the vending machine to authorize the vending machine to dispense the water bottle (e.g., with, or without, the user device present at the machine). In some examples, the user may provide or define (e.g., via one or more user inputs) a one-time code (e.g., numeric code, alpha-numeric code, word, phrase, etc.) to the security key circuitry 310B (and/or the machine terminal server 112).

The NFC token circuitry 310C may comprise one or more of an NFC chip, an NFC transmitter, an NFC receiver, and/or the like for verifying that a user and/or a user device is proximate a machine, establishing a connection, and/or executing an executable action. In some embodiments, the NFC token circuitry 310C may leverage the authentication circuitry 214 on a user device (or the like) to authenticate and/or verify a user and/or a user device. For example, the NFC token circuitry 310C may be configured to receive and/or verify one or more of a user device identifier (e.g., serial number, etc.), a hardware-based security key, a PUF, an IC fingerprint, a biometric reader output, and/or the like generated from the authentication circuitry 214 of a user device. In some embodiments, the NFC token circuitry 310C may be embedded (or configured) within a machine (e.g., ATM, vending machine, etc.). In other embodiments, the NFC token circuitry 310C may be embedded (or configured) within an object (e.g., encased in polyacrylic resin, a sign, statue, lockbox, etc.) external to a machine. For example, an NFC chip may be securely mounted to a wall next to an ATM and the NFC chip may (e.g., by leveraging the security key circuitry 310B and/or the like) periodically transmit a randomly generated code (or the like) indicative of a bank branch where the ATM is located. A user device may receive and utilize the code from the NFC chip to verify (e.g., with the interface translation system 102, the machine terminal server 112, 2FA, and/or the like) that the user device is present at the bank branch. It should be appreciated that by providing an NFC object (e.g., the NFC token circuitry 310C) at a location that is distinct (or separate) from a particular machine, the NFC object may be leveraged by a plurality of machines at a single location (e.g., a hotel lobby, bank lobby, shopping mall, or any other location with various vending machines, ATMs, and/or the like). Additionally, or alternatively, a first machine (e.g., equipped with machine verification agent 310) may be used to verify a user and/or user device for a second machine at approximately the same location (e.g., a hotel, bank, and/or retail location).

In some embodiments, the NFC token circuitry 310C (e.g., comprising an NFC receiver, etc.) may verify the identity of a user device by receiving an identifier (e.g., a mobile identifier, a hardware-based security key, a randomly generated code, etc.) associated with a user and/or a user device. For example, a user device configured with an NFC transmitter may verify its identity to the NFC token circuitry 310C to initiate one or more machine operations as described herein. For example, an ATM (or any other machine described herein) may be configured, at least in part, with an NFC receiver that a user may touch their user device to in order to provide a mobile identifier to verify the user's identity and, in some embodiments, transmit control data comprising instructions (e.g., to withdrawal $40.00 from the ATM or perform any other requested operations as described herein).

It should be appreciated that use of the NFC token circuitry 310C may be beneficial to facilitate (direct and/or indirect) communication between a user device and a machine terminal (e.g., when access to a communications network 104 is unavailable, such as in remote areas with limited Internet and/or cellular service). In some embodiments, the NFC token circuitry 310C (e.g., comprising an NFC transmitter, etc.) may transmit a machine identifier (e.g., a machine serial number, a hardware-based security key, a randomly generated code, etc.) to a user device to identify itself to the user device. For example, a user may tap the user device to the NFC token circuitry 310C to receive a machine identifier which may be used to identify the type, location, APIs, and/or the like associated with the machine to the interface translation system 102. In some embodiments, the communications hardware 306 may comprise, at least in part, the NFC token circuitry 310C.

The machine verification agent 310 may utilize processor 202, memory 204, and/or any other hardware component included in the apparatus 200 to perform the operations as described herein (e.g., in connection with FIGS. 4 and 5A-5B). The machine verification agent 310 may utilize communications hardware 206 to gather data from a variety of sources (e.g., user devices 106A-106N, machine terminals 108A-108N, server farms/clusters, mobile networks, Internet Service Providers (ISP), satellites, and/or any other entity associated with a computing device). The machine verification agent 310 may utilize the communications hardware 206 and/or the user interface circuitry 308 to exchange data with a user and/or user device.

In some embodiments, various components of the apparatus 200 and apparatus 300 may be hosted remotely (e.g., by one or more cloud servers) and thus need not physically reside on the corresponding apparatus (e.g., apparatus 200, apparatus 300, or the like). For instance, some components of an apparatus may not be physically proximate to the other components of the apparatus. Similarly, some or all of the functionality described herein may be provided by third-party circuitry. For example, a given apparatus (e.g., apparatus 200, apparatus 300 and/or the like), may access one or more third-party circuitries in place of local circuitries for performing certain functions.

As will be appreciated based on this disclosure, example embodiments contemplated herein may be implemented by an apparatus 200, an apparatus 300, and/or a combination thereof. Furthermore, some example embodiments may take the form of a computer program product comprising software instructions stored on at least one non-transitory computer-readable storage medium (e.g., memory 204, memory 304, etc.). Any suitable non-transitory computer-readable storage medium may be utilized in such embodiments, some embodiments of which are non-transitory hard disks, CD-ROMs, DVDs, flash memory, optical storage devices, and magnetic storage devices. It should be appreciated, with respect to certain devices embodied by apparatus 200 as described in FIG. 2 and/or apparatus 300 as described in FIG. 3, that loading the software instructions onto a computing device or apparatus produces a special-purpose machine comprising the means for implementing various functions described herein.

Having described specific components of example apparatuses (e.g., apparatus 200 and apparatus 300), example embodiments are described below in connection with a series of flowcharts.

### Example Operations

Turning to FIGS. 4 and 5A-5B, example flowcharts are illustrated that contain example operations implemented by example embodiments described herein. The operations illustrated in FIGS. 4 and 5A-5B may, for example, be performed by a user device (e.g., any or all of user devices 106A-106N) and/or a system device (e.g., server, etc.) of the interface translation system 102 shown in FIG. 1, which may in turn be embodied by an apparatus 200, which is shown and described in connection with FIG. 2. To perform any or all operations described below in connection with the apparatus 200, the apparatus 200 may utilize one or more of processor 202, memory 204, communications hardware 206, user interface circuitry 208, translation agent 210, interface mapping circuitry 212, authentication circuitry 214, geolocation circuitry 216, and/or any combination thereof.

It will be understood that user interaction with the interface translation system 102 may occur directly via the communications hardware 206 and/or the user interface circuitry 208, or may instead be facilitated by a separate user device (e.g., any of user devices 106A-106N shown in FIG. 1, which may in turn be embodied by the apparatus 200, which is shown and described in connection with FIG. 2), and which may have similar or equivalent physical componentry facilitating such user interaction. It will be understood that machine and/or machine terminal (e.g., any of machine terminals 108A-108N) interactions with the interface translation system 102 may occur directly, using the communications hardware 206, and/or may instead be facilitated by the machine terminal server 112, as shown in FIG. 1. In some embodiments, one or more example machines, machine terminals, and/or machine terminal servers may be embodied by an apparatus 300, which is shown and described in connection with FIG. 3. To perform any or all operations described below in connection with the apparatus 300, the apparatus 300 may utilize one or more of processor 302, memory 304, communications hardware 306, user interface circuitry 308, automation hardware 312, machine verification agent 310, and/or any combination thereof.

Turning to FIG. 4, example operations of an example process 400 are shown for translating control instructions for a machine interface.

As shown by operation 402, the apparatus 200 may include means, such as processor 202, memory 204, communications hardware 206, translation agent 210, or the like, for identifying a machine. In some embodiments, the apparatus 200 may identify (e.g., using communications hardware 206) a target machine and/or a location of the target machine via a mapping service website and/or a companion application of the interface translation system 102 (e.g., banking application, retailer application, etc.) prior to arriving at the target machine. For example, a user may use their mobile device to lookup nearby ATMs, vending machines, and/or the like. In some embodiments, the machine comprises one or more of a computing device, a server, a terminal, or an ATM. In some embodiments, the apparatus 200 may identify (e.g., using communications hardware 206) a target machine (e.g., ATM, vending machine, etc) via an NFC sensor (e.g., NFC transmitter and/or receiver circuitry), QR code (or any other indicia described herein), and/or the like associated with the target machine (e.g., by leveraging the machine verification agent 310 of the apparatus 300). For example, a user may be located near a target machine (e.g., machine terminal 108A, an ATM, vending machine, and/or the like and the user may touch their mobile device (e.g., user device 106A) to an NFC sensor at the target machine to exchange data with the machine and/or a machine terminal. Additionally, or alternatively, the user may scan (e.g., using a camera of their mobile device) an indicia (e.g., QR code, etc.) at the target machine to (e.g., establish a connection to) exchange data with the machine, a machine terminal, and/or a machine terminal server (e.g., machine terminal server 112, a remote server, etc.). The operation 402 may comprise identifying, by a translation agent, a machine based on a machine identifier. For example, the apparatus 200 may receive, by translation agent 210 and/or using communications hardware 206, a machine identifier (e.g., a machine serial number, a hardware-based security key, a randomly generated code, etc.). In some embodiments, the apparatus 300 may generate and/or transmit, by machine verification agent 310 and/or using communications hardware 306, a machine identifier (e.g., a machine serial number, a hardware-based security key, a randomly generated code, etc.) indicative of a particular machine (e.g., ATM, vending machine, etc.).

As shown by operation 404, the apparatus 200 may include means, such as processor 202, memory 204, communications hardware 206, user interface circuitry 208, translation agent 210, authentication circuitry 214, geolocation circuitry 216, or the like, for authenticating a user device. The operation 404 may comprise authenticating (or verifying), by a translation agent, a user device based, at least in part, on a user device identifier (e.g., a user device serial number, a hardware-based security key, a randomly generated code, mobile authenticator application, etc.) indicative of a particular user and/or user device (e.g., smartphone, smartwatch, etc.). For example, a user device (e.g., installed with a companion software plugin of the interface translation system 102) may establish a connection with one or more of a server of the interface translation system 102, the machine terminal server 112, any of machine terminals 108A-108N, and/or the like and/or may complete one or more authentication protocols to ensure that the user device is authorized to communicate (e.g., control data, executable instructions, program code, PII, payment information, etc.) with one or more machine terminals (e.g., machine terminal 108A, machine terminal 108N, and/or the like). Some embodiments of the operation 404 are described in further detail below in connection with FIGS. 5A and 5B.

As shown by operation 406, the apparatus 200 may include means, such as processor 202, memory 204, communications hardware 206, translation agent 210, interface mapping circuitry 212, or the like, for selecting a machine-readable interface. The operation 406 may comprise selecting, by a translation agent, a machine-readable interface based on the machine identifier. In some embodiments, the machine-readable interface comprises one or more of a consortium API, an entity-specific API, a computer language, a programming language, and/or the like. For example, the translation agent 210 and/or the interface mapping circuitry 212 may determine, based at least in part on a machine identifier, that a particular machine and/or machine terminal is configured to utilize one or more of a consortium API, an entity-specific API, a computer language, a programming language, and/or the like. In some embodiments, the interface translation system 102 and/or the machine terminal server 112 may transmit an indication to a user device of which machine-readable interface to utilize to communicate with a particular machine and/or a particular machine terminal. In some embodiments, the interface translation system 102 may store a registry, database, or table (e.g., on storage device 110 or the like) that cross-references (or maps) particular machine identifiers to one or more particular machine-readable interfaces. For example, the registry, database, or table may comprise one or more key-value pairs that associate (or link) a key (e.g., a machine identifier) with a value (e.g., a machine-readable interface). For instance, a series of vending machine (or the like) serial numbers may be associated with a consortium API in a key-value pair table and another series of vending machines (or the like) serial numbers may be associated with an entity-specific API (e.g., a manufacturer specific API, etc.) in the key-value pair table. In some embodiments, the translation agent 210 and/or the interface mapping circuitry 212 may leverage the communications hardware 206 to access and/or lookup (or query) one or more key-value pairs (e.g., on storage device 110 or the like) to determine which machine-readable interface to use to communicate with a machine and/or machine terminal. In some embodiments, the translation agent 210 may translate, using the identified machine-readable interface, one or more user interfaces between at least a user device interface format and a machine terminal interface format (as described herein in connection with at least the operation 408). In some embodiments, the translation agent 210 may leverage the interface mapping circuitry 212 to generate, using the identified machine-readable interface, control data (and/or executable instructions) to cause an executable action by a machine (as described herein in connection with at least the operation 408).

As shown by operation 408, the apparatus 200 may include means, such as processor 202, memory 204, communications hardware 206, user interface circuitry 208, translation agent 210, interface mapping circuitry 212, or the like, for generating control data comprising instructions to cause an executable action by the machine. In some embodiments, the operation 408 may comprise generating, by user interface circuitry 208, request data indicating a user request to complete the executable action by the machine. In some embodiments, the operation 408 may comprise generating, by the translation agent 210 and/or the interface mapping circuitry 212 (e.g., using an API and/or an AI system, such as an LLM), the control data comprising instructions to navigate a user interface associated with the machine. For example, the interface mapping circuitry 212 may utilize an API to bridge a mobile application interface with a machine terminal interface (and/or the like) and/or the interface mapping circuitry 212 may utilize an AI system (e.g., an LLM, etc.) to convert the request data indicating a user request into control data. In some such examples, the AI system generated control data may be configured to navigate a user interface associated with the machine and/or to execute one or more executable actions by a machine (e.g., associated with the machine terminal interface). In some embodiments, the user interface comprises one or more of a graphical user interface or an interactive voice response system. In some embodiments, the translation agent 210 (and/or the interface mapping circuitry 212) comprises one or more of an LLM, a domain-specific model, an artificial neural network, or a generative AI model. In some embodiments, an executable action comprises one or more of a financial transaction, a withdrawal, a transfer, a deposit, a balance check, and/or any other operation, action, and/or task that may be performed by a particular machine as described herein. In some embodiments, an executable action may comprise one or more of activating (and/or turning on) a machine, vacuuming, mopping, welding, dispensing an object (e.g., cash, food, a drink, an electronic device such as headphones), and/or the like. In some embodiments, the user interface circuitry 208 may receive (e.g., using a touchscreen, keypad, microphone, etc.) one or more user inputs representative of a user request for a machine to perform an executable action. For example, a user may interact with a mobile banking application interface (e.g., graphical interface buttons, icons, etc.) to indicate a request for an ATM to display an account balance and then (e.g., if the funds are sufficient) to withdrawal an amount of cash (e.g., $20.00 or any other number). In some examples, a user may interact with a mobile banking application interface (e.g., graphical interface buttons, icons, etc.) to indicate a request to an ATM to display an account balance and then (e.g., if the funds are insufficient) to transfer money to the account (e.g., a checking account) from another account (e.g., a savings account). In some embodiments, the interface mapping circuitry 212 may translate (or convert) (e.g., using a machine-readable interface) one or more user inputs (e.g., indicative of a user request) into control data comprising machine-readable and/or machine-executable program code instructions to cause a machine to carry out one or more executable actions (e.g., requested by the user). In some embodiments, the user interface circuitry 208 may render (or present) one or more (familiar or translated) user interfaces generated by the translation agent 210 (at least as described below) and/or receive, using the one or more (familiar or translated) user interfaces, one or more user inputs representative of a user request for a machine to perform an executable action.

Additionally, or alternatively, at the operation 408 the apparatus 200 may include means, such as processor 202, memory 204, communications hardware 206, user interface circuitry 208, translation agent 210, or the like, for translating (e.g., using a machine-readable interface) one or more user interfaces between at least a user device interface format and a machine terminal interface format. In some embodiments, the operation 408 may comprise converting (or translating) an unfamiliar interface to a familiar interface. In some embodiments, the operation 408 may comprise generating a familiar interface based, at least in part, on an unfamiliar interface and/or a machine-readable interface. For example, the translation agent 210 may identify one or more user interface elements associated with a machine terminal interface (e.g., an ATM menu, a phone menu, a vending machine menu, a self-checkout menu, etc.) and translate (or convert) the identified user interface elements into a format associated with a user device interface (e.g., a banking application, a retailer application, a companion application of the interface translation system 102, etc.). In some embodiments, the translation agent 210 may translate or convert an unfamiliar interface (e.g., of a machine and/or machine terminal interface) to a familiar interface (e.g., of a user device application), at least in part, by altering one or more user interface elements associated with the unfamiliar interface. In some embodiments, altering one or more user interface elements may comprise one or more of renaming or relabeling one or more user interface elements, rearranging or reorganizing one or more user interface elements, adding or removing one or more user interface elements, changing a color, size, and/or shape of one or more user interface elements, rendering or outputting one or more user interface elements on a user device (e.g., using the user interface circuitry 208), and/or the like as described herein. In some embodiments, altering one or more user interface elements may be performed based, at least in part, on a frequency of use by a user. For example, the translation agent 210 may determine (e.g., based on historical usage data, or any other data, in a user's profile information) that a user is less likely to withdraw $20.00 than $80.00 and, in response, the translation agent 210 may alter a “Fast Cash: $20.00” ATM interface element to appear smaller and/or lower down on an interface than a “Fast Cash: $80.00” ATM interface element. Additionally, or alternatively, the translation agent 210 may determine (e.g., based on user preferences or settings, or any other data, in a user's profile information) that a user does not prefer diet soft drinks and, in response, the translation agent 210 may alter a “Regular Soda” vending machine interface element to appear larger and/or higher up on an interface than a “Diet Soda” vending machine interface element.

As shown by operation 410, the apparatus 200 may include means, such as processor 202, memory 204, communications hardware 206, or the like, for causing execution of the control data by the machine. In some embodiments, the apparatus 200 may transmit, using communications hardware 206, control data comprising machine-readable and/or machine-executable program code instructions to cause a machine to carry out one or more executable actions (e.g., requested by the user). In some such embodiments, the apparatus 200 may transmit, using communications hardware 206, the control data to one or more of the communications network 104, a machine terminal (e.g., any or all of machine terminals 108A-108N), a server (e.g., a relay server, machine terminal server 112, etc.), and/or the like. For example, the translation agent 210 may generate (e.g., using an API and/or an AI system, such as an LLM) control data locally on a user device and transmit the control data via a wireless connection (e.g., using an NFC transmitter of the user device) to a machine terminal (e.g., using an NFC receiver, such as described below in connection with FIG. 5A). In some examples, the translation agent 210 may generate (or cause generation of) control data on a server of the interface translation system 102 and may transmit the control data via the Internet to the machine terminal server 112 (or a target machine terminal) which may cause execution of the executable actions at a machine terminal (e.g., to control an associated machine).

Additionally, or alternatively, at the operation 410 the apparatus 300 may receive, using communications hardware 306, the control data comprising machine-readable and/or machine-executable program code instructions to cause the apparatus 300 to carry out one or more executable actions (e.g., using the automation hardware 312). In some such embodiments, the apparatus 300 may receive, using communications hardware 306, the control data from one or more of the communications network 104, a user device (e.g., any or all of user devices 106A-106N), a server (e.g., a relay server, machine terminal server 112, a server of the interface translation system 102, etc.), and/or the like. In some embodiments, the apparatus 300 may, at least in part, store the control data to memory 304. In some embodiments, the apparatus 300 may read and/or execute (e.g., using processor 302, etc.) the control data to perform one or more executable actions as described herein. In some embodiments, the apparatus 300 may automatically navigate a user interface (e.g., using processor 302, etc.) based, at least in part, on the control data to mimic a series of user inputs (e.g., indicated in the machine-readable and/or machine-executable program code instructions of the control data). In some embodiments, the apparatus 300 may automatically and/or continuously render (and/or re-render) the user interface (e.g., using user interface circuitry 308) to mimic a series of user inputs (e.g., indicated in the machine-readable and/or machine-executable program code instructions of the control data). For example, the apparatus 300 may automatically and/or continuously render (and/or re-render) the user interface to appear as if an invisible user is pressing buttons of a GUI of a machine terminal until the machine-executable program code instructions of the control data have been fully executed.

In some embodiments, the apparatus 300 may render advertisements (e.g., using user interface circuitry 308) while the machine-executable program code instructions of the control data are executed. For example, a third-party ATM screen may display (or present) products and/or services offered by a user's home bank while the third-party ATM fulfills a request from the interface translation system 102. Additionally, or alternatively, a vending machine speaker may play an audio-based commercial while a user provides inputs and/or establishes a communication channel between the machine terminal and the interface translation system 102. In some embodiments, the user device (e.g., the apparatus 200) may render (or present) advertisements (e.g., using user interface circuitry 208) while the machine terminal (and/or machine) execute the machine-executable program code instructions of the control data.

In some embodiments, the operation 404 may be performed in accordance with the operations described in FIG. 5A. Turning to FIG. 5A, example operations are shown for authenticating a user device (e.g., using, at least in part, NFC technology).

As shown by operation 502, the apparatus 200 may include means, such as processor 202, memory 204, communications hardware 206, authentication circuitry 214, or the like, for contacting an NFC sensor associated with the machine. For example, a user may touch their mobile device (e.g., configured with communications hardware 206 to an NFC sensor (e.g., an NFC receiver of the NFC token circuitry 310C) of a machine terminal. In some such examples, the mobile device (e.g., any of user devices (106A-106N) and a machine terminal (e.g., any of machine terminals 108A-108N) may initiate one or more NFC protocols. In some embodiments, the communications hardware 206 (or the like) may comprise one or more of an NFC receiver, an NFC transmitter, and/or the like as described herein. In some embodiments, the operation 502 may comprise generating one or more of a user device identifier (e.g., serial number, etc.), a hardware-based security key, a PUF, an IC fingerprint, a biometric reader output, and/or the like using the authentication circuitry 214 of a user device.

As shown by operation 504, the apparatus 200 may include means, such as processor 202, memory 204, communications hardware 206, or the like, for transmitting a mobile identifier to the NFC sensor. For example, the mobile device (e.g., any of user devices (106A-106N) may transmit (e.g., wirelessly) a user device identifier to the machine terminal using one or more NFC protocols after initiating communication. In some embodiments, the operation 504 may comprise transmitting one or more of a user device identifier (e.g., serial number, etc.), a hardware-based security key, a PUF, an IC fingerprint, a biometric reader output, and/or the like to the NFC token circuitry 310C of a machine terminal. In some embodiments, the operation 504 may comprise receiving, by an apparatus 300 using, at least in part, the NFC token circuitry 310C, one or more of a user device identifier (e.g., serial number, etc.), a hardware-based security key, a PUF, an IC fingerprint, a biometric reader output, and/or the like generated from the authentication circuitry 214 of a user device.

As shown by operation 506, the apparatus 200 may include means, such as processor 202, memory 204, communications hardware 206, or the like, for establishing a wireless connection to the machine. In some embodiments, the operation 506 may comprise establishing, by communications hardware 206, a direct wireless connection to a machine terminal (e.g., using an NFC protocol peer-to-peer communication mode). In some embodiments, the wireless connection comprises an NFC protocol peer-to-peer communication mode to facilitate the direct exchange of data between a first NFC enabled device (e.g., embodied as the apparatus 200, user device 106A, user device 106N, etc.) and a second NFC enabled device (e.g., embodied as the apparatus 300, machine terminal 108A, machine terminal 108N, etc.). In some such embodiments, the user device may transmit control data (e.g., generated based on the user inputs) to the machine terminal through the established wireless NFC connection. For example, the communications hardware 206, using the NFC connection, can be used to transmit the control data (e.g., instructions, etc.) to a (third-party) machine terminal to allow the user to carry out (and/or execute) one or more desired actions (and/or transactions) without manually navigating the (third-party) machine interface (e.g., using user interface circuitry 308). In some such examples, the apparatus 300, using the NFC connection, may receive the control data from the user device. In some embodiments, the operation 506 may comprise receiving one or more a machine identifier (e.g., a machine serial number, a hardware-based security key, a randomly generated code, etc.). In some embodiments, the operation 506 may comprise transmitting account information (e.g., account number, PIN, etc.) from a user device to a machine (e.g., ATM, vending machine, etc.). In some embodiments, the operation 506 may comprise (e.g., automatically) terminating the established wireless NFC connection upon (and/or in response to) completion of one or more executable actions by a machine and/or a machine terminal. In some embodiments, a user device may be configured to use the established wireless NFC connection to read an interface of the machine terminal, determine and/or select a machine-readable interface, and/or translate the interface to a familiar format (as described herein) before presenting the interface to a user. The user may then provide user inputs (e.g., indications, etc.) to their user device using, at least in part, the familiar interface format.

In some embodiments, the operation 404 may be performed in accordance with the operations described in FIG. 5B. Turning to FIG. 5B, example operations are shown for authenticating a user device (e.g., using, at least in part, a machine terminal server 112).

As shown by operation 508, the apparatus 200 may include means, such as processor 202, memory 204, communications hardware 206, user interface circuitry 208, or the like, for scanning an indicia that is within a distance of the machine. In some embodiments, the indicia may comprise the machine-readable indicia 310A which may comprise one or more of a computer readable code, a Quick Response (QR) code, a data matrix, a barcode, a randomly generated code, a hyperlink, a deep link, and/or the like for verifying that a user and/or a user device is proximate a machine, establishing a connection, and/or executing an executable action. For example, an ATM (or any other machine described herein) may be configured with a QR code that a user device may scan before the ATM will execute any control data received in relation to a request from the particular user device. In some embodiments, a user device may scan (e.g., using a camera, etc.) an indicia to initiate one or more communication protocols to establish a connection to a machine, machine terminal, and/or remote server (e.g., machine terminal server 112, etc.). In some embodiments, the machine-readable indicia 310A may be one or more of a label, a sticker, a sign, an engraving (e.g., on a machine terminal), printed media, digital media, and/or the like as described herein. In some embodiments, the operation 508 may comprise scanning, using a camera (e.g., of a user device, etc.), an indicia that is within a distance of the machine and the indicia may comprise one or more of a QR code, a barcode, an NFC object, and/or the like as described herein.

As shown by operation 510, the apparatus 200 may include means, such as processor 202, memory 204, communications hardware 206, or the like, for contacting a remote server associated with the machine. For example, in response to scanning an indicia comprising a hyperlink, machine identifier, and/or the like (e.g., at the operation 508 above), a user device may navigate to a web portal (or the like) and initiate one or more communication protocols with a remote server associated with the machine (e.g., machine terminal server 112, a server of the interface translation system 102, etc.). In some embodiments, a companion application of the interface translation system 102 may (e.g., automatically) initiate one or more communication protocols based, at least in part, on instructions received from scanning an indicia (e.g., from a deep link, hyperlink, etc.).

As shown by operation 512, the apparatus 200 may include means, such as processor 202, memory 204, communications hardware 206, or the like, for generating a mobile identifier comprising one or more of a user input, a security key, or location data. In some embodiments, the operation 512 may comprise generating data and/or information to identify a user, user device, an account, and/or the like at a remote server (e.g., machine terminal server 112, relay server, media server, etc.). In response to contacting the remote server (e.g., at the operation 510 above), a user may be prompted to provide one or more credentials to the remote server associated with the machine (e.g., machine terminal server 112, a server of the interface translation system 102, etc.). For example, a user may manually input a login and password using the user interface circuitry 208. Additionally, or alternatively, the apparatus 200, using the authentication circuitry 214 and/or the geolocation circuitry 216, may generate data and/or information to identify (and/or authenticate) a user, user device, an account, and/or the like at a remote server. In some embodiments, the operation 512 may comprise generating, by the authentication circuitry 214, a hardware-based security key (and/or any other credentials described herein) representative of a respective mobile device. In some embodiments, a remote server may use geolocking technology and/or techniques to restrict access to one or more of a machine, machine terminal, and/or the like based on a user device's physical location. For example, a remote server may only accept and/or attempt to authenticate (or verify) credentials that are provided from within a particular geolocation (e.g., with a 10 mile radius (or any other number) of a machine terminal, ATM, vending machine, and/or the like to within a ±10% tolerance). In some such embodiments, the remote server may only accept data and/or information for identification if it is accompanied by location data for the user device. In some embodiments, the operation 512 may comprise generating, by the geolocation circuitry 216, location data representative of a physical location (e.g., one or more GPS coordinates, etc.).

In some embodiments, the operation 512 may comprise generating, by user interface circuitry, a user input indicating a code generated by the machine. In some embodiments, the code may comprise one or more of a letter, a number, a symbol, and/or any other distinct identifier. In some embodiments, the code may be a visual code (e.g., rendered on a display device, etc.) and/or an audible code (e.g., emitted by a speaker, phone, etc.). For example, in response to being contacted (e.g., at the operation 510), the remote server associated with the machine may transmit a signal, command data, control data, and/or the like to the associated machine and/or machine terminal instructing the machine and/or the machine terminal to provide a verification code to the user. The verification code may be used (e.g., by the remote server, machine terminal server 112, etc.) to verify that the user is physically at the machine and/or the machine terminal (e.g., before continuing to the operation 514 and/or any other operations described herein).

In some embodiments, the operation 512 may comprise generating, by user interface circuitry, a user input indicating a code selected by a user. In some embodiments, the code may comprise one or more of a letter, a number, a symbol, word, phrase, sentence, and/or any other distinct identifier. For example, in response to being contacted (e.g., at the operation 510), the remote server associated with the machine may request a one-time transaction code to authenticate a user at a machine and/or machine terminal once the user arrives at the machine and/or machine terminal. For example, user may arrive at an ATM without their user device and may be prompted to enter one or more credentials and the code selected by a user to authorize one or more executable actions by the ATM (e.g., withdrawal cash, etc.).

As shown by operation 514, the apparatus 200 may include means, such as processor 202, memory 204, communications hardware 206, or the like, for transmitting the mobile identifier to the remote server. In some embodiments, the operation 514 may comprise transmitting data and/or information (e.g., a mobile identifier, a code generated by a machine, a code selected by a user, etc.) to identify a user, user device, an account, and/or the like at a remote server (e.g., machine terminal server 112, relay server, media server, etc.). In some embodiments, the data and/or information (e.g., a mobile identifier, etc.) may be packaged with location data. In some embodiments, the operation 514 may comprise transmitting, by the communications hardware 206, a mobile identifier, a code, and/or location data representative of a physical location (e.g., one or more GPS coordinates, etc.).

As shown by operation 516, the apparatus 200 may include means, such as processor 202, memory 204, communications hardware 206, or the like, for establishing a connection to the machine, at least in part, via the remote server (e.g., the machine terminal server 112 and/or the like). In some embodiments, the operation 516 may comprise establishing, by communications hardware 206, a connection (e.g., indirect, wireless, wired, etc.) to a machine terminal (e.g., using cellular networks, Wi-Fi, the Internet, etc.). In some embodiments, the connection comprises one or more communication channels over the Internet (and/or any other communications network) to facilitate the (e.g., indirect) exchange of data, at least in part, between a user device (e.g., embodied as the apparatus 200) and a machine terminal (e.g., embodied as the apparatus 300). For example, a user device and a machine terminal may exchange data using one or more intermediate devices, such as the machine terminal server 112, a modem, and/or any other communications infrastructure. In some such embodiments, the user device may transmit control data (e.g., generated based on the user inputs by AI systems) to the machine terminal through one or more established communication channels. For example, the communications hardware 206, using the one or more established communication channels, can be used to transmit the control data (e.g., instructions, etc.) to a (third-party) machine terminal to allow the user to carry out (and/or execute) one or more desired actions (and/or transactions) without manually navigating the (third-party) machine interface (e.g., using user interface circuitry 308). In some such examples, the apparatus 300, using the one or more established communication channels, may receive the control data from the user device. In some embodiments, the operation 516 may comprise receiving one or more a machine identifier (e.g., a machine serial number, a hardware-based security key, a randomly generated code, etc.). In some embodiments, the operation 516 may comprise transmitting account information (e.g., account number, PIN, etc.) from a user device to a machine (e.g., ATM, vending machine, etc.). In some embodiments, the operation 516 may comprise (e.g., automatically) terminating the one or more established communication channels upon (and/or in response to) completion of one or more executable actions by a machine and/or a machine terminal. In some embodiments, a user device may be configured to use the one or more established communication channels to read an interface of the machine terminal, determine and/or select a machine-readable interface, and/or translate the interface to a familiar format (as described herein) before presenting the interface to a user. The user may then provide user inputs (e.g., indications, etc.) to their user device using, at least in part, the familiar interface format.

FIGS. 4, 5A, and 5B illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware, circuitry, etc.) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

Now that the flowchart blocks have been described in detail above, we will walk through a non-limiting example of practical applications of some example embodiments described herein.

In the non-limiting example, a user may authenticate with and traverse a familiar interface of their home bank using the home bank's mobile application (e.g., on their mobile device, laptop computer, etc.) in order to interact with an unfamiliar third-party ATM. Prior to leaving for the ATM, or upon arrival at the ATM, the user may specify a target ATM and/or one or more transactions that they would like the ATM to carry out. The user may specify the one or more transactions (via their home bank's mobile application) and their mobile application (e.g., hosted on apparatus 200 or the like) can generate one or more control instructions (e.g., executable program code, control data, etc.) that will cause the ATM to carry out (or execute) the desired transaction at the specific ATM (e.g., using domain specific knowledge for the third-party ATM, such as provided according to a bank consortium agreement and/or via an API). The user may select and/or identify a target ATM prior to leaving for (e.g., via a map of nearby ATMs), and/or upon arrival at, the target ATM. For example, the user may select and/or identify the target ATM upon arrival by touching their mobile device to an NFC sensor at the target ATM, by providing an identification number (e.g., code, etc.) to the ATM (and/or receiving a code from the ATM for entry into the mobile application on their mobile device), and/or by scanning an indicia (e.g., QR code) printed on (or rendered by) the ATM. In some examples, input of identification number (e.g., code, etc.) provided by an ATM may trigger the mobile application (and/or the interface translation system 102) to generate the specific control instructions used to carry out (or execute) the one or more transactions by the target ATM. In some examples, a graphical control (e.g., a graphical “submit” button and/or the like) on the mobile application may be used to send the control inputs to the target ATM. For example, the control instructions may be sent from a server of a home bank (e.g., after receiving instructions from the user's mobile application) to the target ATM (e.g., via the target bank's intranet and/or using a consortium API). In some examples, the user may be required to enter an on-screen code (e.g., a verification and/or authorization code, a password, a one-time PIN, etc.) displayed on the user's mobile device into the target ATM (e.g., upon arrival at the ATM) to verify that the user is present at the ATM (e.g., with or without their mobile device, such as during a jog, hike, etc.). Additionally, or alternatively, the control instructions may be sent from the user's mobile device to the target terminal by tapping the user's NFC capable (or enabled) mobile device to an NFC sensor of the target ATM. It should be appreciated that using an NFC sensor may provide additional security because the user's mobile device needs to be present at the ATM in order to execute the one or more transactions.

It should be understood that the above-described examples may be used to accelerate carrying out the user's desired action at the target ATM by automating the control instructions (or generation of the control data) used to traverse the target ATM's interface without requiring manual user input (e.g., directly to the ATM). For example, the user can traverse their home bank's mobile application while on the bus (e.g., to select a target ATM, create control instructions, etc.) and, upon arrival at the target bank atm, the user can tap their mobile device to the target ATM's NFC sensor to have the control instructions generated for the target terminal and executed by the target ATM (e.g., without relaying the instructions through a remote server). It should be appreciated that such embodiments allow the user to perform the desired transactions (or other executable actions) on an unfamiliar target ATM quickly (e.g., within 5 seconds or any other number) and/or without separately authenticating (e.g., with a debit card, PIN, etc.) at the target terminal (e.g., where a shoulder surfer or other identity thief could potentially steal the user's PIN and/or skim their debit card information) and without manually traversing the unfamiliar ATM interface. Additionally, the user may not be exposed to third-party advertisements at the target ATM and instead may only see advertisements on the mobile application of the home bank. In some such embodiments, the home bank may pay any third-party transaction fees for the user (e.g., using additional revenue generated from the advertisements). In some examples, an LLM that is provided with access to different bank terminal menu navigation structures (e.g., via one or more APIs) could generate the control instructions without having to hard code control instructions for various distinct third-party ATMs. Similar techniques as described above may be used for third-party vending machines and/or any other machines as described herein.

### Conclusion

As described above, example embodiments provide methods and apparatuses that enable improved user interface technologies for translating a first interface format into a second interface format and/or by generating control data for a machine interface via an application interface of a user device. Example embodiments thus provide tools that overcome the problems faced by application and/or machine interface systems (e.g., banking applications, websites, ATMs, vending machines, industrial robots, etc.) and/or techniques for providing a machine terminal interface to a user. By avoiding the need for users to manually navigate an unfamiliar user interface (e.g., of a machine, machine terminal, etc.), example embodiments can, among other things, save time and provide a more streamline user experience (e.g., via a familiar interface, etc.), while also eliminating the possibility of human error due to trial-and-error attempts to user an unfamiliar machine that has been unavoidable with traditional user interface technologies. Further, by providing improved systems and methods using predefined APIs (e.g., consortium APIs, entity-specific APIs, etc.) and AI systems (e.g., LLMs, GenAI, etc.), example embodiments reduce the need for a user to interact directly with an unfamiliar interface and/or reduce the need for the unfamiliar interface to be directly converted to a familiar format (e.g., in real-time or near-real-time) by providing control instructions (e.g., generated by AI systems) directly from a user device application to a machine and/or machine terminal. Furthermore, embodiments described herein provide additional layers of customization (e.g., user preferences, user settings, etc.) to enable the generation of more tailored (and/or personalized) user interfaces.

As these examples all illustrate, example embodiments contemplated herein provide technical solutions that solve real-world problems faced when a user interacts with an unfamiliar machine terminal (e.g., ATM, vending machine, etc.). And while individual entities (e.g., banks, retailers, etc.) have struggled to standardize user interfaces and/or create more intuitive user interfaces for automated systems, recently emerging automation and AI technologies of today have made this problem significantly more acute, as the expectations of individual customers for quick and easy automated services increases, traditional systems have failed to keep up with these expectations. At the same time, the recently arising ubiquity of mobile devices, automated commercial technologies (e.g., ATMs, self-checkout terminals, vending machine, etc.), and secured digital communications has unlocked new avenues for solving these problems that have not historically been available, and example embodiments described herein thus represent a technical solution to these real-world problems associated with providing more standardized (and/or structured) user interfaces for interacting with third-party machines.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for translating control instructions for a machine interface, the method comprising:
identifying, by a translation agent, a machine based on a machine identifier;
selecting, by the translation agent and based on the machine identifier, a machine-readable interface;
generating, by the translation agent and based on the machine-readable interface, control data comprising instructions to cause an executable action by the machine; and
causing execution, by the translation agent, of the control data by the machine.

2. The method of claim 1, further comprising:
contacting, by communications hardware, an NFC sensor associated with the machine;
transmitting, by the communications hardware, a mobile identifier to the NFC sensor; and
establishing, by communications hardware, a wireless connection to the machine, wherein the wireless connection comprises an NFC protocol.

3. The method of claim 1, further comprising:
contacting, by communications hardware, a remote server associated with the machine;
transmitting, by the communications hardware, a mobile identifier to the remote server; and
establishing, by communications hardware, a connection to the machine, at least in part, via the remote server.

4. The method of claim 1, further comprising generating, by user interface circuitry, a user input indicating a code generated by the machine, wherein the code comprises one or more of a letter, a number, or a symbol, wherein the code is visual or audible.

5. The method of claim 1, further comprising scanning, by a camera, an indicia that is within a distance of the machine, wherein the indicia comprises one or more of a QR code, a barcode, or an NFC object.

6. The method of claim 1, further comprising generating, by authentication circuitry, a hardware-based security key representative of a respective mobile device.

7. The method of claim 1, further comprising generating, by geolocation circuitry, location data representative of a physical location, wherein the location data comprises one or more GPS coordinates.

8. The method of claim 1, wherein the translation agent comprises one or more of an LLM, a domain-specific model, an artificial neural network, or a generative AI model, and wherein the method further comprises:
generating, by user interface circuitry, request data indicating a user request to complete the executable action by the machine; and
generating, by the translation agent, the control data comprising instructions to navigate a user interface associated with the machine, wherein the user interface comprises one or more of a graphical user interface or an interactive voice response system.

9. The method of claim 1, wherein the machine comprises one or more of a computing device, a server, a terminal, or an ATM.

10. The method of claim 1, wherein the machine-readable interface comprises one or more of a consortium API, an entity-specific API, or a computer language.

11. The method of claim 1, wherein the executable action comprises one or more of a financial transaction, a withdrawal, a transfer, a deposit, or a balance check.

12. An apparatus for translating control instructions for a machine interface, the apparatus comprising:
a translation agent configured to:
identify a machine based on a machine identifier;
select, based on the machine identifier, a machine-readable interface;
generate, based on the machine-readable interface, control data comprising instructions to cause an executable action by the machine; and
cause execution of the control data by the machine.

13. The apparatus of claim 12, further comprising:
communications hardware configured to:
contact an NFC sensor associated with the machine;
transmit a mobile identifier to the NFC sensor; and
establish a wireless connection to the machine, wherein the wireless connection comprises an NFC protocol.

14. The apparatus of claim 12, further comprising:
communications hardware configured to:
contact a remote server associated with the machine;
transmit a mobile identifier to the remote server; and
establish a connection to the machine, at least in part, via the remote server.

15. The apparatus of claim 12, further comprising:
user interface circuitry configured to:
generate a user input indicating a code generated by the machine, wherein the code comprises one or more of a letter, a number, or a symbol, wherein the code is visual or audible.

16. The apparatus of claim 12, further comprising:
a camera configured to:
scan an indicia that is within a distance of the machine, wherein the indicia comprises one or more of a QR code, a barcode, or an NFC object.

17. The apparatus of claim 12, further comprising:
authentication circuitry configured to:
generate a hardware-based security key representative of a respective mobile device.

18. The apparatus of claim 12, further comprising:
geolocation circuitry configured to:
generate location data representative of a physical location, wherein the location data comprises one or more GPS coordinates.

19. The apparatus of claim 12, wherein the translation agent comprises one or more of an LLM, a domain-specific model, an artificial neural network, or a generative AI model, wherein the apparatus further comprises:
user interface circuitry configured to:
generate request data indicating a user request to complete the executable action by the machine,
wherein the translation agent is further configured to:
generate the control data comprising instructions to navigate a user interface associated with the machine, wherein the user interface comprises one or more of a graphical user interface or an interactive voice response system.

20. A computer program product for translating control instructions for a machine interface, the computer program product comprising at least one non-transitory computer-readable storage medium storing software instructions that, when executed, cause an apparatus to:
identify a machine based on a machine identifier;
select, based on the machine identifier, a machine-readable interface;
generate, based on the machine-readable interface, control data comprising instructions to cause an executable action by the machine; and
cause execution of the control data by the machine.
